(19) United States
(12) Patent Application Publication
(10) Pub. No.: US 2023/0334516 A1
(43) Pub. Date: Oct. 19, 2023

(54) PRODUCT/SERVICE ORDERING SYSTEM, PRODUCT/SERVICE ORDERING METHOD, AND PROGRAM FOR THE SAME

(71) Applicant: CROSS DREAM CO., LTD, Tokyo (JP)

(72) Inventor: Tsutomu TAJIRI, Shinjyuku-ku, Tokyo (JP)

(21) Appl. No.: 17/996,223

(22) PCT Filed: Apr. 16, 2021
(86) PCT No.: PCT/JP2021/015652

§ 371 Date: Jan. 12, 2023

(30) Foreign Application Priority Data
Apr. 16, 2020 (JP) 2020-073410

(51) Int. Cl. G06Q 30/0203; G06V 30/146; G06F 16/951; G06Q 30/0202

(52) U.S. Cl. CPC G06Q 30/0203; G06V 30/147; G06F 16/951; G06Q 30/0202

(57) ABSTRACT

To provide a product/service ordering system and the like that search for a similar product/image based on a product/service image shot and stored by an orderer and instantly transmit product/service-related information to the orderer, to enable an order to be placed quickly. A product/service ordering system enables an order to be placed based on a product/service image, and includes product/service master information storing means, which is for accumulating information on a product/service in a server; image determining means, which is for performing distinguishing between the product/service image and a product/service similar image extracted from product/service master information accumulated in the server or from external big data that is not accumulated in the server and includes a web article on the Internet; and product/service-related information searching means, which is for searching the product/service master information or the external big data for the information on the product/service.

### TECHNICAL FIELD

The present invention relates to a product/service ordering system, a product/service ordering method, and a program for the same.

### BACKGROUND ART

A product/service ordering system using an information processing device has been known. For example, an information processing device of a product ordering system in PTL1 includes search start instruction receiving means, product name candidate displaying means, product master storing means, search word receiving means, and searching means. The search start instruction receiving means determines a word entered into an input field to be a search word, and receives a search start instruction. Prior to the search start instruction, the product candidate displaying means extracts a product name of a product having a text entered into the input field as part of product information from the product master storing means, and displays product name candidates to be searched below the input field. The search word receiving means receives the selection of the product name to be searched among the product candidates. The searching means executes search processing for the product name candidate received by the search word receiving means.

### CITATION LIST

### Patent Literature

PTL1: JP 2015-079460 A

### SUMMARY OF INVENTION

### Technical Problem

With the product ordering system described in PTL1, a product can be searched for based on data stored in a product master, but only if the product is stored in the product master storing means. Thus, there is a problem that an orderer cannot search for a product not stored in the product master storing means.

The orderer has to input a search word related to the product to be searched for using a terminal, and thus cannot perform an appropriate input unless the orderer comes to mind a search word related to the product in sight. Further, even if the product in sight is stored in the product master storing means, the orderer has to input a search word to a mobile terminal or the like, which prevents a quick acquisition of the product-related information and a quick order of the product. Similarly, for services, there has been no ordering system that is free of such problems.

The present invention is an improvement of a conventional product/service ordering system and the like. An object of the present invention is to provide a product/service ordering system and the like that search for a similar product/image based on a product/service image shot and stored by an orderer and instantly transmit product/service-related information to the orderer so as to enable a quick order.

### Solution to Problem

In order to solve the problems mentioned above, a first invention of the present application relates to a product/service ordering system enabling an order to be placed based on a product/service image.

A product/service ordering system according to the first invention includes product/service master information storing means for accumulating information on a product/service in a server; image recognizing means for recognizing the product/service image; image determining means for distinguishing between the product/service image and a product/service similar image extracted from the product/service master information accumulated in the server or from external big data that is not accumulated in the server and includes a web article on the Internet; and product/service-related information searching means for searching the product/service master information or the external big data for the information on the product/service.

The product/service ordering system according to the first invention of the present application includes the following embodiments.

(1) The image recognizing means includes image recognition processing of outputting image/video data from the product/service image, character string detection processing of extracting a region including a character string from the product/service image, character string recognition processing of outputting the extracted character string in a form of a text, and language analysis processing of performing language analysis on the character string.

(2) The product/service ordering system further includes automatic translation means for automatically translating the character string.

(3) The product/service ordering system further includes orderer information analyzing means for analyzing a product purchasing trend for each orderer with artificial intelligence, based on big data including an order history of an orderer and on results of a questionnaire for a plurality of orderers including the orderer.

A second invention of the present application relates to a product/service ordering method enabling an order to be placed based on a product/service image.

A product/service ordering method according to the second invention of the present application includes: a step to obtain the product/service image by shooting a product or extracting an image of a product from a web; a step to recognize the obtained product/service image and distinguish between the product/service image and a product/service similar image extracted from product/service master information accumulated in a server or from external big data that is not accumulated in the server and includes a web article on the Internet; and a step to search the product/service master information or the external big data for information on the product/service.

The second invention of the present application includes the following embodiments.

(1) The product/service ordering method further includes a step to analyze a product purchasing trend for each orderer with artificial intelligence, based on big data including an order history of an orderer and on results of a questionnaire for a plurality of orderers including the orderer.

A third invention of the present application relates to a program for executing the respective steps in the second invention of the present application.

### Advantageous Effects of Invention

With the product/service ordering system, the product/service ordering method, and the program for the same, according to the present invention, image determining means is included. The image determining means distinguishes between a product/service image and a product/service similar image extracted from product/service master information accumulated in a server or from external big data that is not accumulated in the server and includes a web article on the Internet. Thus, the product similar image can be extracted from the external big data including a massive amount of information on the Internet such as those posted on SNSs, based on the product/service image that is a captured image of a product in front of the orderer, which assures the search for the product information, even if the orderer lacks knowledge on product information on the product in front the orderer or the product similar image is not stored in the product/service master information storing product information on an online shopping site and the like in the business operator server.

### BRIEF DESCRIPTION OF DRAWINGS

The figures illustrate certain embodiments of a product/service ordering system (including a food and drink ordering system) according to the present disclosure, and include optional and preferable embodiments as well as essential embodiments of the invention.

FIG. 1 is an overall diagram schematically illustrating a product/service ordering system according to the present invention.

FIG. 2 is a block diagram schematically illustrating a configuration of an orderer terminal.

FIG. 3 is a block diagram schematically illustrating a function of a business operator server.

FIG. 4 is a flowchart of the product/service ordering system.

FIG. 5 is an overall diagram schematically illustrating a food and drink ordering system according to the present invention.

FIG. 6 is a block diagram illustrating a flow in the food and drink ordering system.

### DESCRIPTION OF EMBODIMENTS

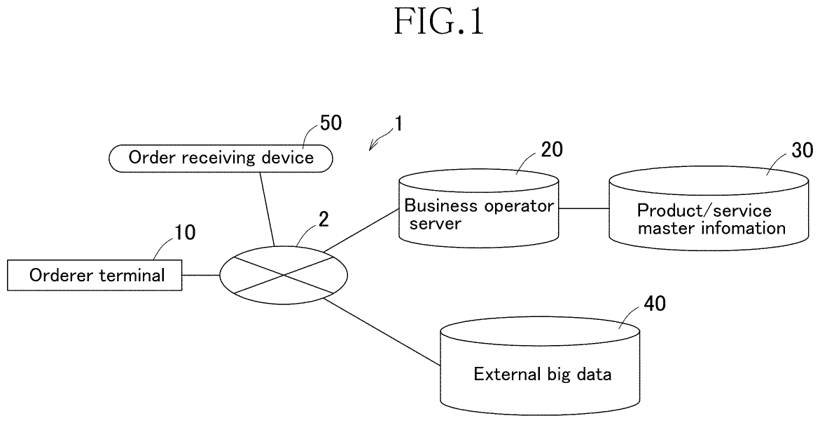

FIG. 1 illustrates a product ordering system according to the present invention. The product/service ordering system 1 includes an orderer terminal 10 used by a client who is an orderer in the system, a business operator server 20 storing a program for the product/service ordering system 1, product master information, and the like, and external big data 40 made up of information on the Internet. The orderer terminal 10, the business operator server 20, and the external big data 40 are configured to be capable of transmitting and receiving information over the Internet 2. For the product/service ordering system 1, known communication means such as Bluetooth (registered trademark) or wireless LAN beacons can be used in addition to the Internet 2.

The business operator server 20 is installed with artificial intelligence (AI) that functions through execution of a program stored in a recording medium (not illustrated) of the business operator server 20. AI is a virtual entity capable of making autonomous decisions so as to substitute a human analysis of data by using control resources and storage resources such as a computer control program. AI, at starting data analysis, is provided with the results of categorizing big data in the business operator server 20 or the external big data 40, and then learns the characteristics of the data categorization.

The term “product/service” used herein means any product and service that can be commercially exchanged, and includes narrowly defined goods that are produced, distributed, and exchanged domestically and internationally, such as those sold at retailers such as supermarkets, convenience stores, and drug stores, and in addition, includes food and drink served by eating establishments such as restaurants and coffee shops, and paid and free services provided by massage parlors, language classes, and the like. Thus, anything photographable with a user terminal can be the product according to the present invention.

The “product/service image” includes images shot planarly in two-dimensions and also stereoscopically in three-dimensions, and means, for example, a moving image of the outer appearance of an actual product, and a still image or a moving image of a lettered signboard and a character string included in the outer appearance. Also, the image refers to services and as an image related to a service, for example, a photograph showing a scene of a yoga class on the web may be used so as to reserve the yoga lesson.

The “product/service master information 30” means information (big data) related to products and services stored/accumulated in the business operator server 20. Examples of such information include a photograph/video of a product, a photograph/video of a service, web information on the price, store, size, type, stock volume, and the like of a product, and web information on the price, provider, content, availability, and the like of a service. The web information is collected and accumulated from any web articles existing on the Internet such as social networking services (SNSs), blogs, review sites, corporate websites, and web news.

The “big data” is a data aggregate so massive and complex that may be is difficult to be processed with a commercially available database or management tool, or with a conventional data processing application. The “external big data 40” of the present invention means publicly accessible contents posted in any web articles existing on the Internet such as SNSs, blogs, review sites, corporate websites, and web news, and data that is saved offline on a smartphone or mobile terminal and is temporarily accessible through communication means such as the Internet.

The external big data 40 relates to a potentially infinite amount of data. This huge amount of data (petabyte or exabyte level) is distributed among a large number of processing servers to be processed based on stream data processing without accumulating data, or stock-type data processing with mass data processing technology. In the present invention, appropriate data is detected through stream processing or batch processing on the big data searched using an existing search engine or a search engine with crawler technology, which is a unique technique developed by the applicant. Thus, the product/service master information (internal big data) 30, which is a huge amount of information accumulated in the business operator server 20, will not be referred to as the external big data herein.

The term “store (retail store)” means all types of retailers selling products on an EC site or in a real store, handling clothes, food, sport equipment, and the like. The term “provider (service providing business operator)” means any service providing business operator providing a paid or free service, such as eating establishments providing food and nursing homes providing nursing services.

An order receiving device 50 is a communication device that is installed in each retailer or each store, and can receive order information transmitted from the orderer terminal 10 over the Internet. As described below, with the AI function also installed on the order receiving device 50, office processing, delivery of a product, and provision of a service can be conducted smoothly after an order is received.

The business operator server 20 is an ordinary computer device including a desktop or a laptop computer, and includes known components such as a central processing unit, a storage part, an input part, and a communication part. The business operator server may be an online server or a local server.

The storage part (recording medium) of the business operator server 20 is installed with a product/service ordering system program (system program) to be processed by the central processing unit. The system program may be stored on the Internet server, or various known storage media (not illustrated) such as a CD-ROM or a USB memory.

The orderer terminal 10 is assumed to be a portable communication device, for example, a smartphone with a touch panel, but may be a laptop computer, a personal digital assistant (PDA), a portable gaming device, a tablet PC, or the like. An orderer program executed on the orderer terminal 10 and the system program executed on the business operator server 20 are communicated using a communication protocol such as the Hypertext Transfer Protocol (HTTP).

The orderer program is installed in the orderer terminal as an application downloaded by the orderer from a website of a business operator, an online application store, or the like. Alternatively, the orderer program may run on a browser or the like, instead of being downloaded onto the terminal as an application.

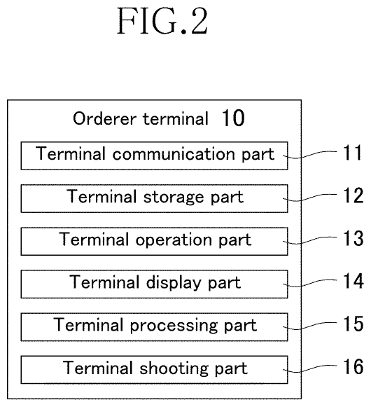

With reference to FIG. 2, the orderer terminal 10 includes, as in a normal portable terminal, a terminal communication part 11, a terminal storage part 12, a terminal operation part 13 including a highly sensitive touch panel mechanism, a terminal display part 14 including a liquid crystal screen, a terminal processing part 15, and a terminal shooting part 16 including a highly sensitive camera mechanism incorporated in a smartphone, a gaming device, a wearable terminal, or the like.

The terminal communication part 11 has a communication interface circuit for connecting the terminal to a mobile communication network. The terminal communication part 11 transmits data received from the business operator server 20 over the Internet 2, to the terminal processing part 15, and transmits data received from the terminal processing part 15 to the business operator server 20 over the Internet 2.

The terminal processing part 15 includes one or more processors and a peripheral circuit for the processor(s), and is capable of executing the orderer program (application). The terminal storage part 12 is a semiconductor memory, a magnetic disk, an optical disc, or the like, and stores various programs and data used for controlling the mobile terminal. For example, the terminal storage part 12 stores a dedicated application and, in addition, a product image shot by the terminal shooting part 16 and product-related information.

The application (orderer program) for using the product/service ordering system 1 is installed in the orderer terminal 10 directly by the orderer, but the installation is not limited thereto. As it is known, the application may be selected on an online store to be automatically installed, with an icon of the application displayed on the terminal, or may also be preinstalled in the orderer terminal 10.

The terminal processing part 15 includes ordering means for transmitting order information on a product to the server in a dedicated application. The orderer can order a product/service by transmitting a product/service image shot by the terminal shooting part 16 of the orderer terminal 10 to the business operator server 20 through the terminal communication part 11.

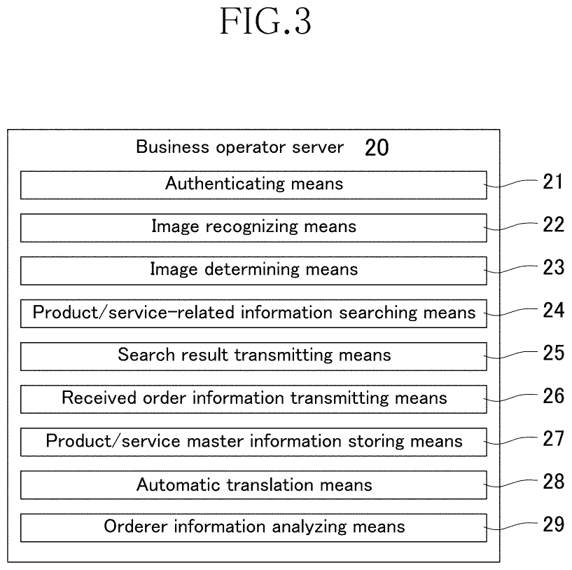

Referring to FIG. 3, the business operator server 20 includes authenticating means 21, image recognizing means 22, image determining means 23, product/service-related information searching means 24, search result transmitting means 25, received order information transmitting means 26, product/service master information storing means 27, automatic translation means 28, and orderer information analyzing means 29.

### <Authenticating Means 21>

The authenticating means 21 is optional, and authenticates the accessing orderer terminal 10 as a registered orderer terminal 10, based on authentication information (such as an ID, a password, or fingerprint) registered (stored) in advance in the business operator server 20 from the orderer terminal 10 over the Internet.

### <Image Recognizing Means 22>

The business operator server 20 has the image recognizing means 22 that includes a recognition algorithm applicable to an image shot by the terminal shooting part 16 and a machine learning method for the algorithm. The processing executed includes image recognition processing to output an image/video data shot by the orderer terminal 10, and further includes character string detection processing to detect a region including a character string from an image shot by the camera, character string recognition processing to recognize the character string region so as to be output as text, and language analysis processing to linguistically analyze the result of the character string recognition processing, understand the meaning and present appropriate (translated) information to the orderer and/or business operator server 20.

The image recognizing means 22 may be executed by the orderer program in the orderer terminal 10. In such a case, the terminal shooting part 16 of the orderer terminal 10 functions as an AI camera to appropriately shoot a target product/service image, so that each processing described above can be executed.

### <Image Determining Means 23>

The image determining means 23 determines whether a product/service image in the big data is coincident with the image shot by the orderer terminal 10. The image determining means 23 searches a plurality of product/service images in the big data for a product/service image (hereinafter, referred to as “similar product/service image”) that is similar to the shot image with a feature coincident rate exceeding a predetermined value (for example, 50%). As an example of a method to calculate the feature coincident rate of a product/service, a point is given according to a predetermined score sheet based on the common and different features between the shot image and the product/service image, and the coincident rate is determined based on the point. A larger number of product images result in a higher search accuracy of product/service information associated with the product/service images by the learning function of AI, which can provide a highly accurate search function.

The image determining means 23 covers not only a product appearance shown by the product/service image but also characters detected through the character string detection processing by the image recognizing means 22. For example, characters of a product name, a store name, or the like in the shot image are effective for searching and are used as reference information for the product being searched by the product information searching means. In a case of an image including texts only such as menus and outdoor signages, a determination on a product can be made by an image of a character string only.

When a determination is made on a service image, for example, even for a shot image of a scene in a certain service provider posted on an SNS or a blog, a website of the business operator providing the certain service can be found through analysis of data on the web. Then, a photograph of the service on the website can be extracted as a similar service photograph.

### <Product/Service-Related Information Searching Means 24>

The product/service-related information searching means 24 searches the product/service master information 30 and/or the external big data 40, for product-related information that is related to a product such as a product name, price, type, and store associated with a product similar image of the business operator.

The “product/service-related information” includes at least a product name, price, type, store, service name, service price, service content, and service provider. Preferably, the information includes the URL of a website (EC site) of the store or the service provider that sells the product on the Internet, so that the orderer can directly place an order.

The “product type” means, for example, distinction among products that are the same in product name, but are different from each other in details such as size and color. For example, in a case where the product in the product image is sneakers (for men, a color black, size 26.5 cm), sneakers with the same specifications are regarded as the same type of product, but sneakers of different specifications such as those for women, of a color blue, or of a size 25.0 cm are regarded as a different type of product.

The predefined search processing is, for example, as follows. First of all, when a similar product image is found on a plurality of webpages in the product/service master information 30 in the business operator server 20, character information commonly used is extracted from all the pieces of character information on the plurality of webpages posting the similar product/service image. The character information used commonly among the plurality of webpages is likely to be product information related to a product such as a product name, price, product type, and store. For example, product information such as a photographic image, product name, price, or store of a product X is a document relating to the same product X, and thus is likely to be used commonly.

The product information is classified based on various words in the character information commonly appearing unique to the product information and an object arranged close to the similar product image. For example, character information that is a combination of a number and a currency unit is likely to be product information related to the price of the product. General and related terms used in the product industry are likely to be the name of a store. The product name is arranged close to the similar product image in many cases. The product type is expressed using standardized terms such as S size and blue. Thus, the similar product/service image and the product information can be obtained through the search processing.

If the similar product/service image fails to be found in the product/service master information 30 in the business operator server 20, or if a sufficient amount of information fails to be extracted, a search for the similar product image is performed in the external big data 40 additionally or in tandem. The external big data 40 encompasses all the web information existing on the Internet, and thus the similar product image can be found without fail, as long as the product/service image is extracted from a web article.

### <Search Result Transmitting Means 25>

The search result transmitting means 25 transmits a result of the product search by the product/service-related information searching means 24 to the orderer terminal 10. The search result transmitted to the orderer terminal 10 is displayed on a program (application) running on the terminal display part 14 of the orderer terminal 10.

The orderer that has received the product search result uses the terminal operation part 13 to perform an order operation on a store (provider) included in the product (service) information, based on the product search result displayed on the terminal display part 14 of the orderer terminal 10, that is, the product/service image and the product-related information. The product order can be placed on the Internet, by clicking an icon displayed on the application, and also by phone, facsimile, or other conventional methods.

### <Received Order Information Transmitting Means 26>

The received order information transmitting means 26 transmits the order information from the orderer terminal 10 to the order receiving device 50 owned by the store dealing with the product (provider of the service). The store or the like conducts an order entry of the product based on the order information, and ships the product or provides the service.

### <Product/Service Master Information Storing Means 27>

Preferably, the product/service master information storing means 27 newly or additionally stores the product/service image and the product/service-related information obtained from the big data on the Internet. For example, when the product photograph of and the product/service related-information on the product X are not present in the product/service master information storing means 27, the product photograph of and the product/service-related information on the product X are newly stored. Thus, the amount of information in the big data stored in the product/service master information storing means 27 is increased, and the information is used for the machine learning by AI, whereby the search accuracy and the search speed in the product/service ordering system 1 can be improved.

### <Automatic Translation Means 28>

Through the language analysis processing in the image recognizing means 22, a character string in any of 18 or more non-Japanese languages such as English, Chinese, Korean, French, and Russian included in the product/service image can be automatically translated into Japanese or other desired languages.

For example, when the system 1 is set up in Japanese and a character string in English is included in the product/service image, the character string is translated into Japanese and displayed on the terminal display part 14 of the orderer terminal 10 or stored in the product/service master information storing means 27. The automatic translation means 28 performs the automatic translation through real-time processing or batch processing. The translated character string is displayed at the display position of the original text in an overwriting or adding manner, and is stored. The automatic translation means 28 may be stored in a program in the orderer terminal 10, and not in a program in the business operator server 20.

<Orderer information analyzing means 29>

The product/service ordering system 1 includes the orderer information analyzing means 29 to analyze a product purchasing trend or the like of the orderer. The orderer information analyzing means 29 collects big data including a purchase history of an orderer and results of a questionnaire for the orderer and many other orderers, analyzes a purchasing trend of a product or services for each orderer based on the collected big data using AI, and extracts a product suitable for each orderer based on a result of the analysis. The data on the result of the questionnaire includes but is not limited to, age, gender, address (region), products of interest, products purchased in the past, and expectation elements at the purchase (for example, performance, price, small and light weight, or easy to handle). In other words, any data can be used as long as a product purchase trend can be easily analyzed with it.

Based on the result of the analysis by the orderer information analyzing means 29, images of a plurality of products may be displayed as “recommended products” classified by product categories, before the orderer orders a product on a display screen of the orderer terminal 10. When the orderer actually orders a product, product information associated with the product image can be instantly searched for based on the result of the analysis.

The product/service ordering system 1 may have a product inquiry function of making a direct inquiry on details of the product/service to a retailer or a service providing business operator as an option before or after the order information is transmitted. With such a function, the orderer can check the content of the product/service more in detail before placing an order, or change and correct the order information.

A function can be provided for directly transmitting the feedback or complaints on a product to a call center of a retail store or service providing business operator from the orderer terminal 10, after the product has been delivered or the service has been provided.

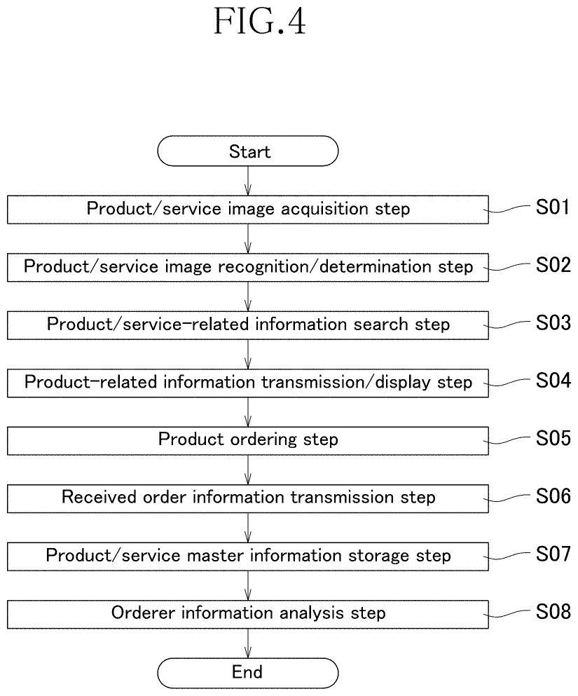

FIG. 4 is a flowchart illustrating the process of application of the product/service ordering system 1.

### <Product/Service Image Acquisition Step S01>

The orderer logs into the product/service ordering system 1 using the authenticating means 21, starts the application, and shoots an image of a target product (service) using the terminal shooting part 16 of the orderer terminal 10 to obtain the product/service image. The product/service image can be uploaded to the system 1, by operating a shot image or a saved image extracted from the web in accordance with a predetermined display in the application. The automatic translation means 28 is executed by the program stored in the orderer terminal 10 or the business operator server 20, and preferably performs the automatic translation through real-time processing or batch processing when the image is obtained. Thus, the orderer can check the product-related information on the product image before transmitting the order information, with a translated character string in the product image obtained.

### <Product/Service Image Recognition/Determination S02>

Next, the image recognizing means 22 recognizes a product photograph, a character string, and the like in the product/service image obtained, and determines whether the product/service image obtained coincident with a product/service similar image obtained from the product/service master information 30 in the business operator server 20 or the external big data 40 on the Internet. When the product/service image includes a character string, the character string is used in a product/service-related information search step S03.

Thus, the product similar image can be extracted from the external big data 40 including a massive amount of information on the Internet such as those posted on SNSs, based on a product image that is a shot image of a product in front of the orderer. Thus, the product information can be found without fail, even if the orderer lacks knowledge on product information on the product in front of the orderer or the product similar image is not stored in the product/service master information 30 storing product information such as an online shopping site in the business operator server 20.

### <Product/Service-Related Information Search Step S03>

The product information searching means searches the product/service master information 30 in the business operator server 20 or the external big data 40 on the Internet for the product/service-related information required for the purchase related to a product such as a product (service) name, price, product (service) type, and store (provider) associated with the product image, through predetermined search processing provided with the AI learning function. The product/service image recognition/determination step S02 and the product/service-related information search step S03 may be performed concurrently or sequentially, or may be performed for a plurality of times or repeated in loop.

### <Product-Related Information Transmission/Display Step S04>

The product-related information is transmitted to the orderer terminal 10, and the product/service-related information associated with the product/service image found is displayed in a predetermined display format, on an application running on the terminal display part 14 of the orderer terminal 10.

### <Product Ordering Step S05>

The orderer places an order a product/service with a store/provider included in the product/service-related information, using the terminal operation part 13 of the orderer terminal 10.

### <Received Order Information Transmission Step S06>

The order information transmitted from the orderer terminal 10 is received by the order receiving device 50 installed in the store/provider. The store/provider arranges the product based on the received order information, Specifically, a retailer packs the product to be ready for delivery to the orderer, while a service providing business operator such as an eating establishment delivers ordered food to the orderer's home, or serve the food to an orderer in the restaurant. Furthermore, a provider of a service such as yoga or massage arranges the lesson or treatment based on the reservation information of the received order, and transmits the reservation confirmation to the orderer.

The order information received by the order receiving device 50 may be output in paper by an output device connected to the order receiving device, such as a facsimile machine or a printer.

With AI installed on the order receiving device 50, it is preferable that a series of operations after receipt of order information be automated, that is, Robotic Process Automation (RPA) be implemented. After an order information is received by an order receiving device in a retail store, for example, the following operations are automated, that is, the product stock is checked and the checking is transmitted to a management server in a warehouse storing the product, the product packing is arranged, the delivery is arranged to a delivery company, and a billing of the product is settled. Thus, a series of operations can be seamlessly performed from an order placement/receipt through a product delivery and a billing settlement.

Similarly, in a case where the order receiving device 50 of the service providing business operator receives order information, for example, when an eating establishment receives order information on food and drink on a menu for delivery or eat-in, the following operations are automated, that is, the order is transmitted to a kitchen or serving staff, the cooking is ordered and done, the delivery or serving is arranged, and the payment is settled. Thus, a series of operations can be seamlessly performed from an order placement/receipt through a delivery and a payment, for the ordered menu.

### <Product/Service Master Information Storage Step S07>

In a product master information storage step S07, the product/service master storing means stores the product/service image and the product/service-related information. With the image and the information stored in the product/service master information storing means of the business operator server 20, a product similar image and appropriate product/service-related information can be extracted in more speedy and accurate manner, compared with a case where the image and the information are directly extracted from the big data on the Internet.

### <Orderer Information Analysis Step S08>

The product/service ordering system 1 accumulates order big data of product order information on the user in every category such as order date, order product, order price, order service details, and service price. The order big data can be regarded as information to grasp an ordering trend of the prospective orderer. Information such as a usage trends of store or site by users, hobby trends, income, and household composition, enables an appropriate promotional strategy (advertising strategy) to be analyzed. The promotional strategy can be, for example, display advertising of an appropriate website, and the transmission of advertising mail related to campaigns and events, based on user information on a specific user.

The product/service ordering system 1 according to the present invention enables speedy and easy product ordering in various industrial fields including retail stores and eating establishments such as restaurants and cafes, public bath and spa, simple lodgings for foreigners, hot spring inns, tourist hotels, amusement facilities such as casinos and pachinko, event and festival venues selling food and drink and goods, and liquor stores. In particular, the system is less troublesome compared to a direct ordering to store staff and free of language barriers, and thus is effective for inbound tourism associated with an recent increase in foreign tourists.

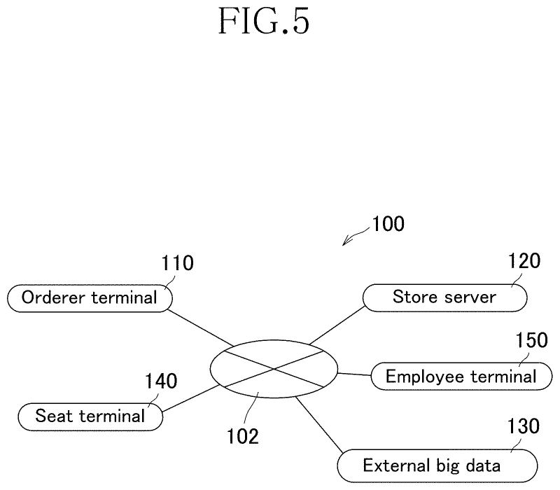

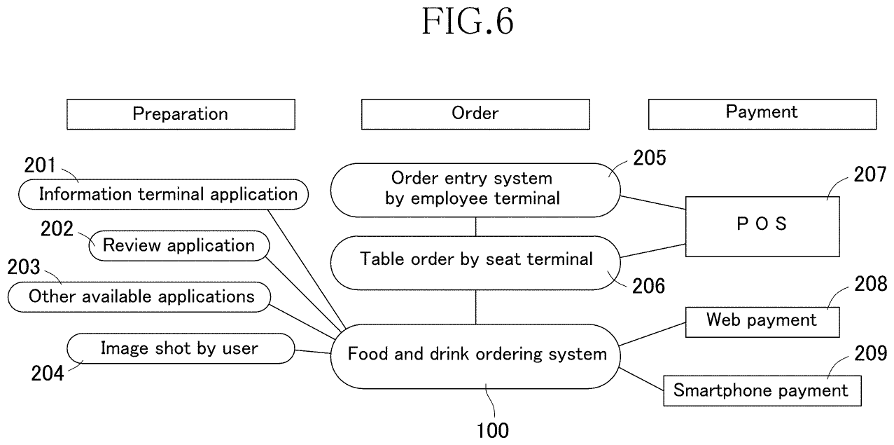

FIG. 5 is an overall block diagram illustrating a food and drink ordering system 100 employing the product/service ordering system 1 according to the present invention. FIG. 6 is a block diagram illustrating a flow of a series of operations from an order placement through payment for food and drink in the food and drink ordering system 100. The food and drink ordering system 100 has a configuration similar to that of the product/service ordering system 1.

With reference to FIG. 5, the food and drink ordering system (product/service ordering system 1) 100 includes a store server 120, which stores a program for the food and drink ordering system 100 and food and drink master information; an orderer terminal 110, which is owned by an orderer; an employee terminal 150, which receives order information from the store server 120; a seat terminal 140, which is installed in a seat or table in the store; and external big data 130, which is made up of web information on the Internet. The orderer terminal 110, the store server 120, the employee terminal 150, the seat terminal 140, and the external big data 130 are configured to be capable of transmitting and receiving information over the Internet. The store server 120 serves as both the business operator server 20 and the order receiving device 50 of the product/service ordering system 1. However, this embodiment should not be construed in a limiting sense, and the business operator server may be included in the system network in addition to the store server 120 serving as the order receiving device.

The orderer obtains the product-related information based on the food and drink image stored in the orderer terminal 110 or the seat terminal 140, and transmits the order information to the store server 120. As the food and drink image, images can be used that are posted on an information terminal application 201 used by the orderer to post the service information on a store, a review application 202 posting a review of other users, and other available applications 203, as well as a food and drink image 204 shot by the user and images prestored in the seat terminal 140.

The food and drink ordering system 100 is provided with the automatic translation means 28, and thus a menu in a foreign language is automatically translated so as to be read in Japanese. The image to be shot may be, in addition to the menu, a signboard located in front of or inside the store, point-of-purchase advertising in the store, an advertising leaflet, food served on the next table, and a bottle of wine placed in the store.

The orderer can order the delivery of food and drink by transmitting order information at a location other than a store such as home, and can considerably save waiting time for ordering in a restaurant by transmitting order information in time for a reservation time. For placing new or additional orders at seat in the restaurant, the orderer may take a conventional way to use order entry system 205 by employee terminal 150 that transmits the order directly to inside staff, or may use table order system 206 by operating a tablet of seat terminal 140.

For billing settlement of food and drink by each restaurant, web payment 208 and smartphone (mobile) payment 209 are available for orders received by orderer terminal 110 while POS payment 207 is available for orders received by employee terminal 150 or seat terminal 140. Further, web payment 208 and smartphone payment 209 are available in seat terminal 140.

The orderer terminal 110 is installed with an AI camera capable of automatically recognizing a menu to place an order. Thus, a digital transformation of the order enables user's visit, order, and payment to be seamlessly linked. The orderer information analyzing means 29 uses the AI function to analyze user's order history such as visiting time, the food and drink ordered, payment amount from a huge amount of the user's information (big data) accumulated, and to determine an appropriate promotional strategy. Thus, automatic promotion (advertisement) can be achieved by the AI function.

In recent years, IT-based ordering systems have been established in the tourism and apparel industries, while IOT-based automation of operation has been advancing in the manufacturing industry. In the food service industry, however, IT literacy is low and there has been no ordering system based on the AI function. The food and drink ordering system according to the present invention can provide a novel ordering system including the AI function that has not previously existed.

Specifically, the food and drink ordering system according to the present invention is regarded as a novel support interface for eating establishments to enable the order and payment respectively within one minute by adopting cutting-edge technologies including AI image recognition, fintech (cashless), and big data (AI analysis). The system considerably improves work efficiency from conventional ordering systems, so that the number of store employees can be reduced, whereby cost reduction can be achieved and a recent problem of labor shortage in the food service industry can be solved. Furthermore, the system can be used through a simple operation on a mobile terminal familiar to the user, and thus can be regarded as being usable not only by young people but also by elderly people who are not familiar with IT devices. Also, the external big data 130 is used, and there is no need to accumulate the master information on products in the store server 120, thus the server is less loaded and maintenance-free of its system, which is excellent in convenience.

### REFERENCE SIGNS LIST

1 product/service ordering system
2 the Internet
10 orderer terminal
20 business operator server (server)
23 image determining means
27 product/service master information storing means
28 automatic translation means
29 orderer information analyzing means
30 product/service master information
40 external big data
100 food and drink ordering system (product/service ordering system)
110 orderer terminal
130 external big data

1. A product/service ordering system enabling an order to be placed based on a product/service image, the product/service ordering system comprising:
product/service master information storing means for accumulating information on a product/service in a server;
image recognizing means for recognizing the product/service image;
image determining means for distinguishing between the product/service image and a product/service similar image extracted from the product/service master information accumulated in the server or from external big data that is not accumulated in the server and includes a web article on the Internet; and
product/service-related information searching means for searching the product/service master information or the external big data for the information on the product/service.

2. The product/service ordering system according to claim 1, wherein the image recognizing means includes image recognition processing of outputting image/video data from the product/service image, character string detection processing of extracting a region including a character string from the product/service image, character string recognition processing of outputting the extracted character string in a form of a text, and language analysis processing of performing language analysis on the character string.

3. The product/service ordering system according to claim 1, further comprising automatic translation means for automatically translating the character string.

4. The product/service ordering system according to claim 1, further comprising orderer information analyzing means for analyzing a product purchasing trend for each orderer with artificial intelligence, based on big data including an order history of an orderer and on results of a questionnaire for a plurality of orderers including the orderer.

5. A product/service ordering method enabling an order to be placed based on a product/service image, the product/service ordering method comprising:
a step to obtain the product/service image by shooting a product or extracting an image of a product from a web;
a step to recognize the obtained product/service image and distinguish between the product/service image and a product/service similar image extracted from product/service master information accumulated in a server or from external big data that is not accumulated in the server and includes a web article on the Internet; and
a step to search the product/service master information or the external big data for information on the product/service.

6. The product/service ordering method according to claim 5, further comprising a step to analyze a product purchasing trend for each orderer with artificial intelligence, based on big data including an order history of an orderer and on results of a questionnaire for a plurality of orderers including the orderer.

7. A program for executing the respective steps according to claim 5.
